(19) United States
(12) Patent Application Publication
(10) Pub. No.: US 2014/0290662 A1
(43) Pub. Date: Oct. 2, 2014

(54) Filter Material and Face Mask

(71) Applicant: MOLDEX-METRIC, INC., CULVER CITY, CA (US)

(72) Inventor: Frank Kern, Pliezhausen (DE)

(73) Assignee: MOLDEX-METRIC, INC., CULVER CITY, CA (US)

(21) Appl. No.: 13/999,470

(22) Filed: Feb. 27, 2014

(30) Foreign Application Priority Data
Aug. 14, 2009 (DE) EPA09010514.9

(51) Int. Cl. A62B 23/02; A41D 13/11

(52) U.S. Cl. CPC A62B 23/025; A41D 13/11
USPC 128/206.19

(57) ABSTRACT

The present invention relates to a filter material for respirator masks. The filter material comprises a filter material layer that is pleated so as to form a plurality of folds, said filter material layer comprising a filter layer and a first netting layer. The invention is characterized in that the filter material layer comprises a second netting layer disposed on the filter layer on the side opposite to said first netting layer. The invention additionally relates to a respirator mask comprising such a filter material.

This Continuation Application is based on U.S. application Ser. No. 12/802,998 filed on Jun. 17, 2010 by Frank Kern for Filter Material and Face Mask.

The present invention relates to a filter material comprising a filter material layer that is pleated so as to form a plurality of folds as well as to a respirator mask provided with such a filter material.

A filter material of the type in question and a respirator mask provided with said filter material are known from DE 298 15 881 U 1. The pleated filter material layer comprises three layers: a netlike stabilizing layer, a central filter layer and a cover layer consisting of a spun-bonded web (non-woven), said layers being arranged one on top of the other in this sequence.

Respirator masks and filter materials provided for such masks are subjected to a large number of partly contradictory demands. The primary aim is here always the reliable protection of breathing air against dust and other pollutions. For providing wear comfort, it is, however, important that the mask clings closely to the wearer's face and, in particular, that the moisture of the exhaled air is removed from the mask interior fast enough. Last but not least, the mask must be so stable that, when exposed to loads, it will not prematurely become brittle and therefore permeable.

It turned out that the conventional pleated filter mask still has improvement potential as regards the simultaneous fulfillment of all these demands. It is therefore the object of the present invention to provide, with the aid of means that are structurally as simple as possible, a filter material and a respirator mask provided with such a filter material, which optimally satisfy all the demands that have to be fulfilled by them.

The filter material according to the present invention is characterized in that the pleated filter material layer also comprises a second netting layer disposed on the filter layer on the side opposite to said first netting layer. In the conventional filter material, the first netting layer already imparts to the pleated material the necessary stability so that the folds are prevented from collapsing. Hence, a second netting layer on the opposite side of the filter layer could be dispensed with. On the contrary, it even had to be reckoned with that the provision of a further netting layer will lead to an increase in the air flow through resistance.

Surprisingly enough, it turned out that the provision of the second netting layer even leads to a substantial decrease in the air flow through resistance. In the case of a given geometry of the folds and with a flow rate of 95 l/min, the air resistance can decrease from 140 Pa to 75 Pa, i.e. more than 45%. This means that, on the basis of an unchanged efficiency of the filter, an enormous increase in comfort for the wearer of a respirator mask provided with said filter material will be achieved, since the wearer will be able to inhale and exhale with less effort. This will reduce symptoms of fatigue of the wearer of the mask, especially when he is under severe physical strain, and, in the final analysis, it will also substantially improve his working reliability and performance.

According to a preferred embodiment, at least one of the netting layers comprises ethylene vinyl acetate (EVA) and/or polypropylene (PP). The netting layers may also consist of a mixture of these two materials. Neither of these materials absorbs moisture and the materials are very stable.

It will be expedient when at least one of the netting layers has a grammage in the range of 30 gr/m2 to 200 gr/m2. The ideal grammage is in the range of 50 gr/m2 to 70 qr/m2, in particular 60 gr/m2.

According to an advantageous embodiment, at least one of the netting layers has regular mesh or network structures, e.g. rectangular or rhombic network structures. Such network structures impart to the netting layer and, consequently, to the whole filter material layer a high stability while permitting simultaneously a high air flow rate.

When the network structures are rhombic, the shorter diagonal of the network structures can have dimensions between 1.5 mm and 4.0 mm, whereas the longer diagonal of the network structures has dimensions between 2.5 mm and 6.0 mm. According to an even more advantageous embodiment, the shorter diagonal has a length in the range of 2.0 mm to 3.0 mm, whereas the longer diagonal has a length between 3.5 mm and 4.5 mm.

The filter material according to the present invention will offer special advantages, when two layers of the filter material layer are in direct contact with one another in the folds. In the case of the conventional material, this had the effect that the respective areas of the filter layer became ineffective, since only a minor amount of air could be exchanged between the inner and the outer side of the filter material layer. In the case of the material according to the present invention, however, the air can be deflected to the side via the second netting layer so as to be transferred form the inner to the outer side of the filter material. Hence, the fact that the layers of the filter material layer are disposed in contact with one another will no longer reduce the effective filter area, but it renders the existing area useful.

Normally, the filtering effect and the air flow through resistance can already be improved substantially when the two layers of the filter material layer are in contact with one another on one side thereof. However, these two parameters will be improved to an even higher degree, when the two layers of the filter material layer are in contact with one another on both sides thereof at the folds, since in this case the size of the filter layer area that can be provided per unit area of the filter material can be increased still further.

The present invention also relates to a respirator mask comprising a cup-shaped mask body including the filter material according to the present invention.

When two layers of the filter material layer are in contact with one another at the folds of the filter material, this contact should preferably exist on the outer side of the folds. In this way, bags will be formed between neighboring folds on the inner side of the filter material layer, and the air can flow into and spread within said bags so that the air flow through resistance will decrease.

Such bags will especially be formed when, on the inner side of the folds, two neighboring layers of the filter material layer are spaced apart.

The inner side of the respirator mask is preferably provided with a non-woven mask material consisting e.g. of PP. Also the filter layer of the filter material may consist of polypropylene.

In the following, an advantageous embodiment will be explained in detail making reference to a drawing, in which:

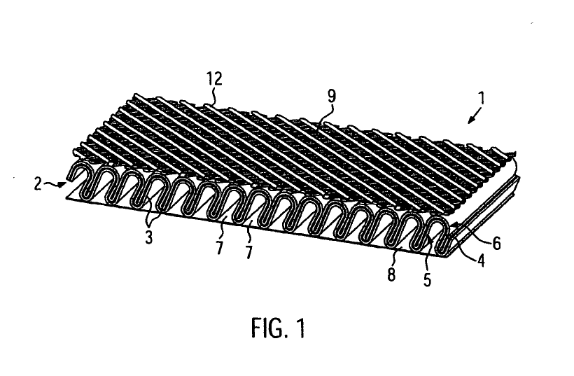

FIG. 1 shows a perspective view of a detail of a filter material according to the present invention,

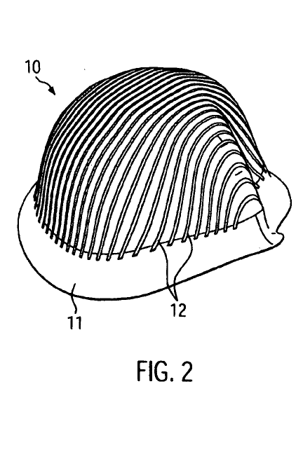

FIG. 2 shows a perspective view of a respirator mask according to the present invention, and

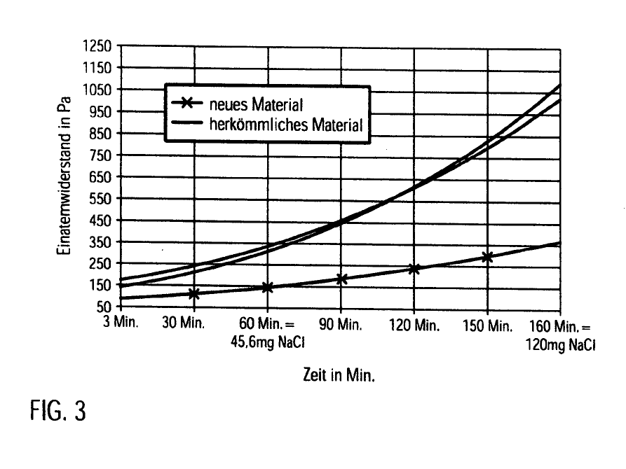

FIG. 3 shows a comparison between the inhalation resistance of the filter material according to the present invention and that of conventional materials.

Identical components are provided with identical reference numerals in all the figures.

FIG. 1 shows a perspective view of a filter material 1 according to the present invention. The principal item of this filter material is a multilayer filter material layer 2 which is pleated so as to form folds 3.

The central layer of this filter material layer 2 is a filter layer 4 consisting e.g. of polypropylene (PP). It serves to prevent dust and other particles from passing through the filter material layer 2, while allowing simultaneously an exchange of air and perhaps vapor.

The side of the filter layer 4 that will face the mask interior later on is provided with a first netting layer 5, whereas a second netting layer 6 is provided on the opposite side, i.e. on the outer side of the filter layer 4. Both netting layers can be formed of an EVA/PP mixture. According to one embodiment, they have rhombic network structures in which the dimensions of the two diagonals are 2.5 mm and 4.0 mm. According to the preferred embodiment, each netting layer has a netting grammage of 60 gr/m2.

In the embodiment shown, the neighboring layers of the filter material layer 2 are in contact with one another on one side thereof, i.e. on their outer side. The folds 3 are implemented such that a line-to-line or even an aerial contact is established between the neighboring layers of the material. This contact is established between two neighboring portions of the second netting layer 6.

On the thus defined inner side of the mask, two neighboring layers of the filter material layer 2 are spaced apart. In this way, a bag 7 is defined between two neighboring folds 3, and air can flow into said bag 7 from the inner side of the filter material 1.

The formation of the folds of the filter material layer 2 can take place in the way described in DE 298 15881 U1, preferably after heating of said filter material layer. After having cooled down, the filter material layer 2 maintains the fold structure.

In order to enhance the wear comfort, the filter material 1 is provided with a continuous nonwoven mask material 8 on the inner side thereof. This non-woven mask material 8 forms a smooth surface which enhances the wear comfort.

The outer side of the filter material layer 2 has provided thereon a mask lattice 9 which is continuous as well. Whereas the non-woven mask material consists of polypropylene, the mask lattice 9 is preferably made of an EVA/PP mixture. In order to increase the stability of the filter material 1 and, in particular, of the folds 3, and in order to prevent a displacement of the filter material layer 2 in the filter material 1, the non-woven mask material 8 and/or the mask lattice 9 may be connected to the filter material layer 2. Since all the materials are thermoplastic materials, the respective layers can be permanently connected to one another by a thermal process, i.e. by partial melting or by fusing.

FIG. 2 shows a respirator mask 10 according to the present invention, which consists of the filter material 1. The filter material 1 is shaped such that a mask body 11 is formed, which is adapted to the anatomical shape of the wearer's face in the best possible way. On the convex outer side of the mask body 11, the longitudinal elements 12 of the mask lattice 9 can be seen. For the sake of clarity, other components of the respirator mask 10 are not shown, such components being e.g. a respirator valve or an elastic band for attaching the respirator mask 10 to the wearer's head.

FIG. 3 shows a comparison between the respiratory resistance of the filter material 1 according to the present invention and that of conventional materials for respirator masks. This figure shows the development over time of the inhalation resistance in Pa under specific test conditions. It can be seen that the inhalation resistance of the filter material 1 according to the present invention lies substantially below the reference values of the conventional materials, so that the energy required for inhaling and exhaling will be reduced essentially. Nevertheless, the filter material according to the present invention has, per unit area, a much larger effective area of the filter layer 4 than e.g. the material according to DE 298 15 881 with its zigzag folds. This enlarged effective filter area provides a much higher particle storage efficiency. Hence, the mask need not be exchanged as frequently as conventional masks.

Starting from the embodiment shown, the filter material 1 according to the present invention and the respirator mask 10 according to the present invention can be modified in many respects. For example, other materials can be chosen for the various layers, or the geometry of the network structures can be modified.

1. A respirator mask comprising a cup-shaped mask body, which cup-shaped mask body is formed entirely from a filter material layer which is pleated so as to form a plurality of folds, said pleated filter material layer comprising a filter layer and a first netting layer, characterized in that the pleated filter material layer comprises a second netting layer disposed on the filter layer on the side opposite to said first netting layer to form a pleated structure and further characterized in that the respirator mask is additionally provided with a mask lattice overlaying one side of the pleated structure.

2. A respirator mask according to claim 1, characterized in that, on the outer side of the folds, two layers of the filter material layer are in contact with one another.

3. A respirator mask according to claim 1, characterized in that, on the inner side of the folds, two neighboring layers of the filter material layer are spaced apart.

4. A respirator mask according to claim 1, characterized in that the respirator mask is provided with the mask lattice on the outer side thereof

5. A respirator mask according to claim 1, characterized in that the respirator mask is provided with a non-woven mask material on the inner side thereof.

6. A respirator mask according to claim 1, characterized in that the mask lattice is fixedly connected to the filter material layer.

7. A respirator mask according to claim 5 characterized in that the non-woven mask material is fixedly connected to the filter material layer.
